(19) United States
(12) Patent Application Publication
(10) Pub. No.: US 2024/0131397 A1
(43) Pub. Date: Apr. 25, 2024

(54) SERVICE PROVIDING APPARATUS

(71) Applicant: TS TECH CO., LTD., Asaka-shi, Saitama (JP)

(72) Inventors: Hiroyuki KAKU, Shioya-gun, Tochigi (JP); Munetaka KOWA, Shioya-gun, Tochigi (JP); Akira MIYOSHI, Shioya-gun, Tochigi (JP); Michinobu WAKU, Shioya-gun, Tochigi (JP)

(21) Appl. No.: 18/546,877

(22) PCT Filed: Feb. 3, 2022
(86) PCT No.: PCT/JP2022/004204

§ 371 Date: Aug. 16, 2023

Related U.S. Application Data
(60) Provisional application No. 63/153,442, filed on Feb. 25, 2021.

(30) Foreign Application Priority Data
Mar. 22, 2021 (JP) 2021-048238

(51) Int. Cl. A63B 24/00; A63B 21/00; A63B 71/06; B60N 2/00; B60N 2/90

(52) U.S. Cl. CPC A63B 24/0075; A63B 21/4027; A63B 71/0622; B60N 2/0027; B60N 2/90; B60N 2002/981

(57) ABSTRACT

A service providing apparatus includes a detector provided on a seat and configured to detect a motion of a user seated on the seat; a control device including a processor and a memory coupled to the processor, having a plurality of service functions and configured to determine a service content in the plurality of service functions based on the motion detected by the detector and a presentation unit configured to present the service content determined by the control device.

### CROSS-REFERENCE TO RELATED APPLICATION

This application is a National Stage of PCT international application Ser. No. PCT/JP2022/004204, filed on Feb. 3, 2022, which designates the United States, incorporated herein by reference, and which is based upon and claims the benefit of priority from U.S. Provisional Patent Application No. 63/153,442, filed on Feb. 25, 2021, and Japanese Patent Application No. 2021-048238, filed on Mar. 23, 2021, the entire contents of which are incorporated herein by reference.

### TECHNICAL FIELD

The present invention relates to a service providing apparatus that provides a service to a user seated on a seat.

### BACKGROUND ART

As this type of device, there has been conventionally known an apparatus configured to change the setting of an air conditioner provided on a vehicle seat in accordance with the state of a seated person (refer to Patent Literature 1, for example). The apparatus described in Patent Literature 1 determines a sleep state of whether a seated person is awake or asleep based on a pulse wave detected by a wearable device, and changes the temperature of air conditioning according to the sleep state.

### CITATION LIST

### Patent Literature

Patent Literature 1: Japanese Unexamined Patent Publication No. 2019-137178

### DISCLOSURE OF INVENTION

### Problems to be Solved by the Invention

However, since the apparatus described in Patent Literature 1 merely changes the setting of the device mounted in the vehicle based on the sleep state of the seated person, the apparatus lacks versatility and has a problem in applicability to various services.

### Means for Solving Problem

An aspect of the present invention is a service providing apparatus, including: a detector provided on a seat and configured to detect a motion of a user seated on the seat; a control device including a processor and a memory coupled to the processor, having a plurality of service functions and configured to determine a service content in the plurality of service functions based on the motion detected by the detector; and a presentation unit configured to present the service content determined by the control device.

### Effect of the Invention

According to the present invention, it is possible to provide a user seated on a seat with various services according to the state of the user.

### BRIEF DESCRIPTION OF DRAWINGS

FIG. 1A is a perspective view of an example of a seat to which a service providing apparatus according to a first embodiment is applied.

FIG. 1B is a diagram illustrating a modification of a seat device of FIG. 1A.

FIG. 2A is a partially cross-sectional view of an internal structure of the seat of FIGS. 1A and 1B.

FIG. 2B is a diagram illustrating a state where an air cell of FIG. 2A is expanded.

FIG. 3 is a diagram for describing a detection range of a pressure sensor of FIGS. 1A and 1B.

FIG. 4 is a block diagram illustrating an overall configuration of the service providing apparatus according to the first embodiment.

FIG. 5 is a diagram illustrating an example of screen display of a monitor of FIGS. 1A and 1B.

FIG. 6 is a flowchart illustrating an example of processing executed by the service providing apparatus according to the first embodiment.

FIG. 7 is a diagram illustrating an overall configuration of a sofa system according to a second embodiment.

FIG. 8 is a front view of a sofa.

FIG. 9 is a top view of seat cushions.

FIG. 10 is a functional block diagram of the sofa system.

FIG. 11 is a diagram illustrating a display example on a display unit in a posture diagnosis mode.

FIG. 12 is a flowchart illustrating control operations of a portable information terminal.

FIG. 13 is a flowchart illustrating control operations of a control device.

FIG. 14 is a flowchart illustrating detailed processing in step S19 of FIG. 12 and step 34 of FIG. 3.

FIG. 15 is a front view of a modification of the sofa.

FIG. 16 is a side view of the modification of the sofa.

FIG. 17 is a diagram illustrating another example of a seat pad.

### DESCRIPTION OF EMBODIMENT

### First Embodiment

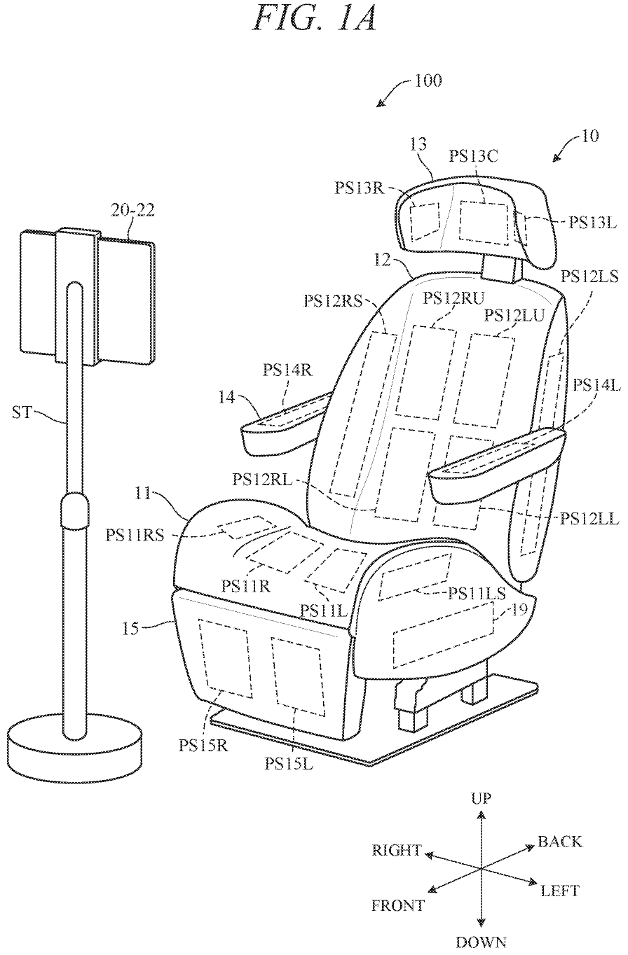

Hereinafter, a first embodiment of the present invention will be described with reference to FIGS. 1A to 6. A service providing apparatus according to the first embodiment is applied to a seat that functions as a controller that executes an application program (hereinafter, an application). Hereinafter, an example in which the service providing apparatus is applied to a seat installed in a common space of a nursing care facility or the like and a rhythm game application is executed will be described.

FIG. 1A is a perspective view of an example of a seat 10 to which the service providing apparatus according to the first embodiment is applied. In FIG. 1A, the front-back direction, the horizontal direction, and the vertical direction are defined as illustrated with respect to the user seated on the seat 10. As illustrated in FIG. 1A, the seat 10 includes a seat cushion part 11, a seat back part 12, a headrest part 13, an armrest part 14, and an ottoman part 15.

The parts 11 to 15 of the seat 10 are each provided with pressure sensors PS that detect pressure exerted on the seat 10 from each part of the body of the user seated on the seat 10, inside a seating surface 10a in contact with the user seated on the seat 10.

The seat cushion part 11 is provided with pressure sensors PS11L and PS11R that detect pressure exerted downward from the left and right thighs of the user, respectively, and pressure sensors PS11LS and PS11RS that detect pressure exerted sideward from the left and right thighs, respectively. That is, the pressure sensors PS11L and PS11R are configured to detect the motion of the user moving the thighs up and down, and the pressure sensors PS11LS and PS11RS are configured to detect the motion of the user opening and closing the thighs left and right.

The seat back part 12 is provided with pressure sensors PS12LL and PS12RL that detect pressure exerted rearward from the left and right waist parts of the user, respectively, and pressure sensors PS12LU and PS12RU that detect pressure exerted rearward from the left and right shoulders, respectively. The seat back part 12 is further provided with pressure sensors PS12LS and PS12RS that detect pressure exerted from the left and right upper arms of the user to the sides.

That is, the pressure sensors PS12LL and PS12RL are configured to detect the motion of the user twisting the waist, and the pressure sensors PS12LU and PS12RU are configured to detect the motion of the user twisting the upper body. The pressure sensors PS12LS and PS12RS are configured to detect the motion of the user opening and closing the upper arms left and right.

The headrest part 13 is provided with a pressure sensor PS13C that detects pressure exerted rearward from the head of the user and pressure sensors PS13L and PS13R that detect pressure exerted leftward and rightward from the head, respectively. That is, the pressure sensor PS13C is configured to detect the motion of the user moving the head back and forth, and the pressure sensors PS13L and PS13R are configured to detect the motion of the user moving the head left and right.

The armrest part 14 is provided with pressure sensors PS14L and PS14R that detect pressures exerted downward from the left and right forearms of the user, respectively. That is, the pressure sensors PS14L and PS14R are configured to detect the motion of the user moving the forearms up and down.

The ottoman part 15 is provided with pressure sensors PS15L and PS15R that detect pressures exerted rearward from the left and right lower thighs of the user, respectively. That is, the pressure sensors PS15L and PS15R are configured to detect the motion of the user moving the lower thighs back and forth.

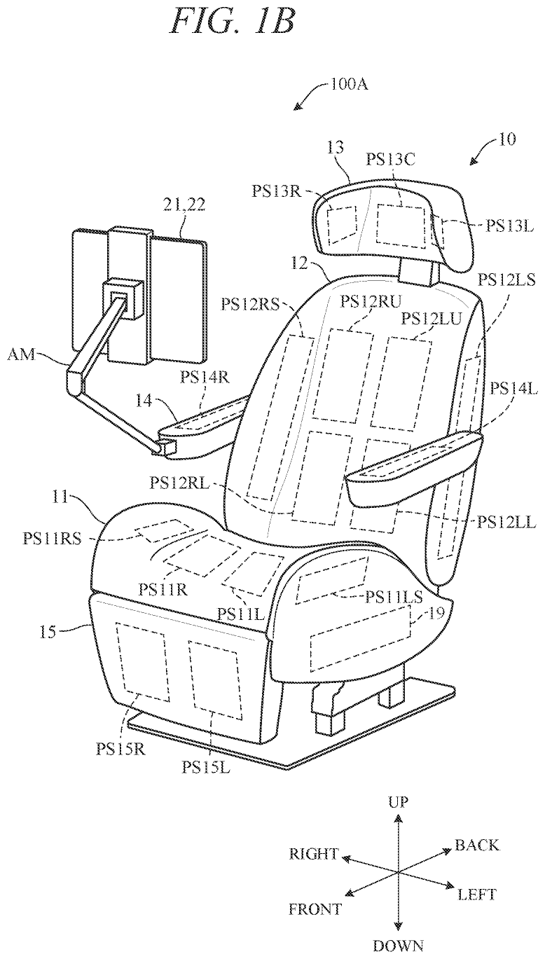

FIGS. 2A and 2B are partially cross-sectional views of an internal structure of the seat 10, and illustrate the internal structure of the seat 10 at the right armrest part 14 as an example. As illustrated in FIG. 2A and FIG. 2B, the seat 10 has a seat frame 16 inside, and has cushion material 17 such as urethane that covers the seat frame 16, and a seat cover 18 of leather or cloth that covers the cushion material 17. The pressure sensors PS are provided on the back side of the seating surface 10a of the seat cover 18, for example.

As illustrated in FIGS. 2A and 2B, an air cell AS that presses a user seated on the seat 10 is provided near each pressure sensor PS. The air cell AS is fixed to the seat frame 16, for example, and is connected to a compressor (not illustrated), and is adjusted in expansion amount by adjusting an internal air amount. When the expansion amount of the air cell AS is adjusted, a pressing force Fa by which the air cell AS presses the user seated on the seat 10 is adjusted.

In an initial state in which the air cell AS is not expanded as illustrated in FIG. 2A, when the user presses the seating surface 10a in the vicinity of the pressure sensor PS with a force of a predetermined value F1 or more, the pressure sensor PS detects the motion of the user (in the example of FIG. 2A, an operation of lowering the right forearm). On the other hand, in a state where the air cell AS is expanded as illustrated in FIG. 2B, when the user presses the seating surface 10a in the vicinity of the pressure sensor PS with a force of a predetermined value F2 (F2=F1+Fa) or more against a pressing force Fa from the air cell AS, the motion of the user is detected by the pressure sensor PS.

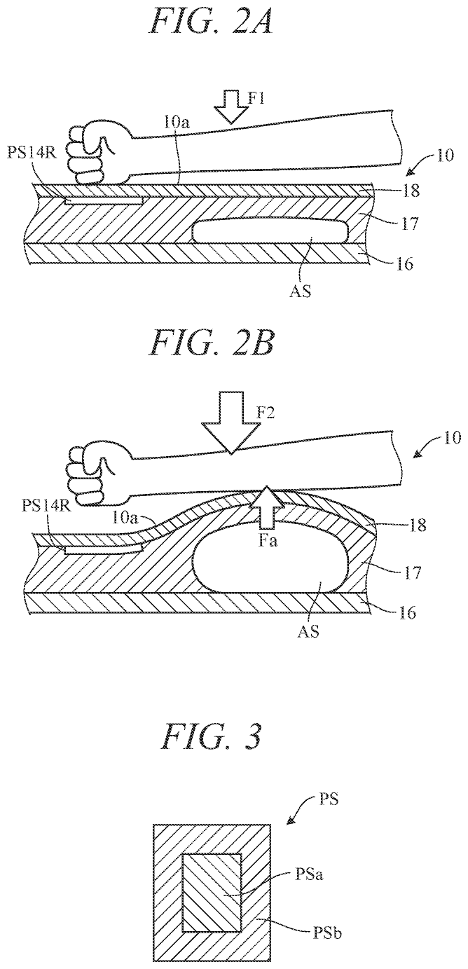

FIG. 3 is a diagram for describing a detection range of the pressure sensor PS, which schematically illustrates the pressure sensor PS viewed from the seating surface 10a side. As illustrated in FIG. 3, some of the pressure sensors PS include a plurality of (in the example of FIG. 3, two) pressure sensors PSa and PSb. A set of a plurality of pressure sensors may be the pressure sensors PSa and PSb. For example, the pressure sensors PS11LS and PS11RS (seat cushion part 11), PS12LS and PS12RS (seat back part 12), PS14L and PS14R (armrest part 14), and PS15L and PS15R (ottoman part 15) include a plurality of pressure sensors.

As a result, a detection range AR in which the motion of the user is detected on the seating surface 10a can be switched between the case of using only the pressure sensor PSa and the case of using the pressure sensor PSa and the pressure sensor PSb, for example. That is, the detection range AR can be switched between a detection range AR1 corresponding to the pressure sensor PSa and a detection range AR2 corresponding to the pressure sensor PSa and the pressure sensor PSb to change the area of the detection range.

As illustrated in FIG. 1A, the seat 10 is provided with a controller 19. The pressure sensors PS and air cells AS (compressor actuators) of the parts 11 to 15 of the seat 10 are connected to the controller 19. The controller 19 is connectable to a user terminal 20 such as a tablet terminal via short-range wireless communication such as Bluetooth (registered trademark) or Wi-Fi (registered trademark).

The user terminal 20 includes an input unit 21 such as a touch panel that receives an input operation by the user and a microphone that receives a voice input, and an output unit 22 such as a monitor 23 that displays a screen and a speaker 24 that outputs a voice. The user terminal 20 is supported by a stand ST whose height and angle are adjustable such that the monitor 23 is visible to the user seated on the seat 10, for example. The controller 19 and the user terminal 20 function as a single computer that executes an application based on an input operation received by the input unit 21 and controls the operation of the output unit 22. The seat 10 including the controller 19 and the user terminal 20 are collectively called seat device 100.

FIG. 1B is a diagram illustrating a modification of the seat device 100. As illustrated in FIG. 1B, the input unit 21 and the output unit 22 may be integrated with the seat 10. For example, the input unit 21 and the output unit 22 are supported by an arm AM provided in the armrest part 14 such that the monitor 23 is visible to the user seated on the seat 10. In this case, the controller 19 is connected to the input unit 21 and the output unit 22 by wire using an HDMI (registered trademark) cable or the like, executes an application based on an input operation received by the input unit 21, and controls the operation of the output unit 22.

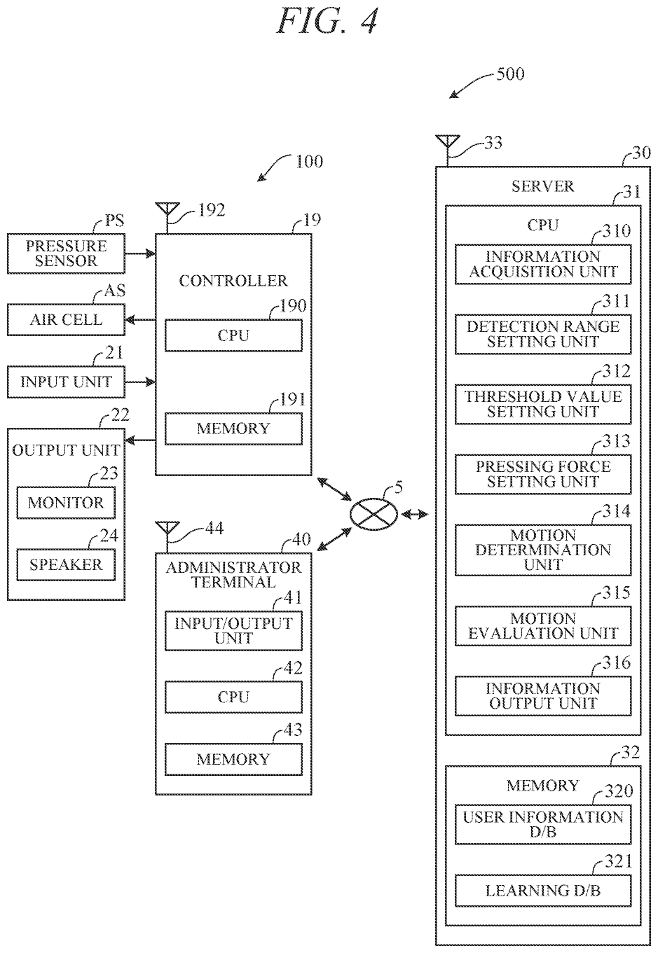

FIG. 4 is a block diagram illustrating an overall configuration of the service providing apparatus according to the embodiment of the present invention, and illustrates a service providing system 500 constituting the service providing apparatus. As illustrated in FIG. 4, the service providing system 500 includes the seat device 100, a server 30, and an administrator terminal 40 used by an administrator who manages the physical condition of the user. The seat device 100, the server 30, and the administrator terminal 40 are connected to a network 5 including a public wireless communication network typified by the Internet, a mobile phone network, or the like, and are configured to be communicable with each other via the network 5.

FIG. 4 illustrates one seat device 100 and one administrator terminal 40 for convenience, but the service providing system 500 may include a plurality of seat devices 100 or a plurality of administrator terminals 40. Although FIG. 4 illustrates a single server 30, the functions of the server 30 illustrated in FIG. 4 may be distributed to a plurality of servers.

As illustrated in FIG. 4, the controller 19 of the seat device 100 includes an electronic control unit, and includes a computer including a CPU 190, a memory 191 such as a ROM and a RAM, a communication unit 192, and other peripheral circuits. The pressure sensors PS and the air cells AS (compressor actuators) of the parts 11 to 15 of the seat 10, the input unit 21, and the output unit 22 including the monitor 23 and the speaker 24 are connected to the controller 19.

The communication unit 192 is configured to be wirelessly communicable with the server 30 via the network 5. The memory 191 stores data of an application installed in advance, data received from the server 30 via the network 5, and the like. The CPU 190 executes predetermined processing based on the data stored in the memory 191 and the data received from the server 30 according to the signal input via the input unit 21, and controls the operation of the output unit 22 (the monitor 23 and the speaker 24). For example, the CPU 190 executes a pre-installed rhythm game application.

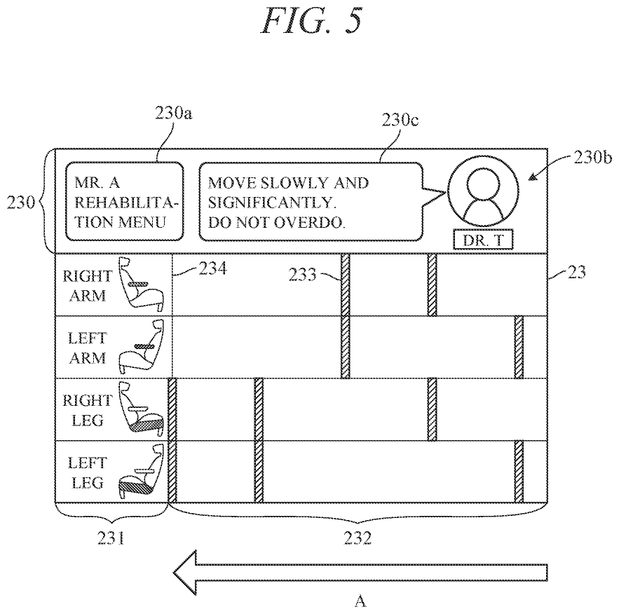

FIG. 5 is a diagram illustrating an example of screen display of the monitor 23 (output unit 22), and illustrating an example of screen display during execution of the rhythm game application. The rhythm game is a game in which the user hits the parts 11 to 15 of the seat 10 corresponding to the pressure sensors PS in accordance with music output from the speaker 24.

As illustrated in FIG. 5, displayed on a user display part 230 at the upper part of the monitor 23 are a user name of the user playing the rhythm game (display part 230a), an administrator in charge of the user (display part 230b), a message from the administrator (display part 230c), and the like. Displayed on a target display part 231 at the lower left of the user display part 230 are the parts of the seat 10 corresponding to the pressure sensors PS (in the example of FIG. 5, the pressure sensors PS14R, PS14L, PS11R, and PS11L) as targets to be hit by the user by characters or illustrations.

A plurality of (in the example of FIG. 5, 10) timing icons 233 for teaching a timing for hitting the target displayed on the target display part 231 are displayed on a timing display part 232 at the lower right of the user display part 230. The timing icons 233 are displayed corresponding to each target, and are displayed in such a manner as to flow from a right end to a left end 234 of the timing display part 232 along the direction of an arrow A in accordance with the music output from the speaker 24. The timing for hitting each target is expressed as a timing with which the timing icon 233 corresponding to the target reaches the left end 234 of the timing display part 232.

That is, in the example of FIG. 5, a series of motions of hitting the seat cushion part 11 twice with both legs, hitting the armrest part 14 once with both arms, hitting the armrest part 14 with the right arm, hitting the seat cushion part 11 with the right leg, hitting the armrest part 14 with the left arm, and hitting the seat cushion part 11 with the left leg is taught. In other words, a series of motions of moving the right and left thighs up and down twice, moving the right and left forearms up and down once, moving the right forearm and the right thigh up and down simultaneously, and moving the left forearm and the left thigh up and down simultaneously in a state of being seated on the seat 10 is taught.

The user seated on the seat 10 can perform exercise in a seated state while enjoying the rhythm game by making the motions taught via the screen display on the monitor 23 in accordance with the music output from the speaker 24. Such exercise performed in a seated state is recommended as exercise for rehabilitation or exercise for prevention of nursing care for the elderly, for example. Since the purpose of exercise and the physical condition are different for each user, it is preferable to perform exercise according to the physical condition of the user for effective exercise.

The administrator terminal 40 in FIG. 4 is a personal computer, a tablet terminal, or the like used by an administrator who manages the physical condition of the user. The administrator is a physical therapist in charge of rehabilitation of the user, a personal trainer in charge of training of the user, or the like, for example. The administrator can suggest an appropriate exercise program for performing rehabilitation or training according to the physical condition of the user.

As illustrated in FIG. 4, the administrator terminal 40 includes an input/output unit 41 such as a keyboard, a mouse, and a monitor, and includes a computer including a CPU 42, a memory 43 such as a ROM and a RAM, a communication unit 44, and other peripheral circuits. The communication unit 44 is configured to be wirelessly communicable with the server 30 via the network 5. The memory 43 stores data of an application installed in advance, data received from the server 30 via the network 5, and the like. The CPU 42 executes predetermined processing based on the data stored in the memory 43 and the data received from the server 30 according to signal input via the input/output unit 41, and controls the operation of the input/output unit 41.

In general, in order to effectively perform rehabilitation and training, it is preferable to continuously perform exercise according to the user's purpose and physical condition on a daily basis. On the other hand, since the physical condition of the user changes, it is necessary to suggest an appropriate exercise program in consideration of the daily physical condition of the user.

The server 30 in FIG. 4 includes a computer including a CPU 31, a memory 32 such as a ROM and a RAM, a communication unit 33, and other peripheral circuits. The CPU 31 includes, as functional components, an information acquisition unit 310, a detection range setting unit 311, a threshold value setting unit 312, a pressing force setting unit 313, a motion determination unit 314, a motion evaluation unit 315, and an information output unit 316. The memory 32 includes a user information D/B 320 and a learning D/B as functional components. The communication unit 33 is wirelessly communicable with each of the seat device 100 and the administrator terminal 40 via the network 5.

The user information D/B 320 stores user information of each user registered in advance in association with a user ID. The user information includes each user's user ID, age, gender, attributes such as hometown, exercise purpose, and the like. The learning D/B 321 stores information not including personal information permitted to be provided by each user among the user information stored in the user information D/B 320.

The information acquisition unit 310 acquires various types of information transmitted from the seat device 100 and the administrator terminal 40. The information transmitted from the seat device 100 includes user information and exercise program proposal request information input by the user via the input unit 21, pressure information detected by the pressure sensors PS of the parts 11 to 15 of the seat 10, and the like. The information transmitted from the administrator terminal 40 includes information regarding proposal of an exercise program input by the administrator via the input/output unit 41, information regarding evaluation of the physical condition after execution of the exercise program, and the like. The various types of information acquired by the information acquisition unit 310 are stored in the user information D/B 320 as user information of each user.

The information regarding the proposal of the exercise program input by the administrator includes a questionnaire regarding the physical condition of the user on that day and information regarding the preparatory exercise for checking the physical condition, responses to the questionnaire, and the exercise program suggested according to the results of the preparatory exercise. The information regarding the evaluation of the physical condition after execution of the exercise program includes information regarding criteria for evaluating the physical condition of the user according to the evaluation results of the motion of the user during the execution of the exercise program. The user information input by the user includes information of responses to the questionnaire issued by the administrator.

The exercise program is suggested with specification of the number of motions in which the user moves each part of the body, continuity, speed (time interval between motions), intensity, and the like. The administrator may suggest an exercise program as a series of combined motions according to the length and speed of a particular song.

The detection range setting unit 311 sets the detection range AR in which the motion of the user is detected by the pressure sensors PS on the seat device 100, based on the information acquired by the information acquisition unit 310. More specifically, the detection range AR is switched between the detection range AR1 corresponding to the pressure sensor PSa in FIG. 3 and the detection range AR2 corresponding to the pressure sensor PSa and the pressure sensor PSb.

That is, when the information acquisition unit 310 acquires the user information including the user ID and the information of a request for proposal of an exercise program, the detection range setting unit 311 sets the detection range AR based on the user information stored in the user information D/B 320. More specifically, the detection range setting unit 311 sets the detection range AR based on the information regarding the proposal of an exercise program from the administrator in the user information corresponding to the user ID.

More specifically, the detection range setting unit 311 switches the detection range AR of the pressure sensors PS11LS and PS11RS provided in the seat cushion part 11 in FIGS. 1A and 1B between the detection range AR1 and the detection range AR2. When the detection range AR is set to the detection range AR1, the motion is unlikely to be recognized unless the centers of the pressure sensors PS11LS and PS11RS are accurately hit, as compared with the case where the detection range AR is set to the detection range AR2. Switching the detection ranges AR in this manner makes it possible to switch the accuracies of the motion of opening and closing the thighs to the right and left requested to the user.

Similarly, the detection range setting unit 311 switches the detection ranges AR of the pressure sensors PS12LS and PS12RS of the seat back part 12, thereby to switch the accuracies of the motion of opening and closing the upper arms to the left and right requested to the user. The detection range setting unit 311 changes the detection range AR of the pressure sensors PS14L and PS14R of the armrest part 14, thereby to change the accuracy of the motion of moving the forearms up and down requested to the user. The detection range setting unit 311 switches the detection ranges AR of the pressure sensors PS15L and PS15R of the ottoman part 15, thereby to switch the accuracy of the motion of moving the lower legs back and forth requested to the user.

The threshold value setting unit 312 sets the predetermined value F1 (FIG. 2A) with which the motion of the user is detected by the pressure sensors PS on the seat device 100 based on the information acquired by the information acquisition unit 310. That is, like the detection range setting unit 311, when the information acquisition unit 310 acquires the user information including the user ID and the information of a request for proposal of an exercise program, the threshold value setting unit 312 sets the predetermined value F1 based on the user information stored in the user information D/B 320.

If the predetermined value F1 is set to a large value, the motion is unlikely to be recognized unless the pressure sensors PS are strongly hit. Changing the predetermined value F1 makes it possible to change the intensity of the motion requested to the user. The predetermined value F1 can be set for each pressure sensor PS. For example, the predetermined value F1 can be set according to the user's state such as the user's purpose of exercise (rehabilitation, training, and target body part), age (attribute information), and physical condition on that day (response to a questionnaire).

The pressing force setting unit 313 sets the pressing force Fa (FIG. 2B) with which the seat device 100 presses the user by the air cell AS based on the information acquired by the information acquisition unit 310. That is, like the detection range setting unit 311 and the threshold value setting unit 312, when the information acquisition unit 310 acquires the user information including the user ID and the information of a request for proposal of an exercise program, the threshold value setting unit 312 sets the pressing force Fa based on the user information stored in the user information D/B 320.

Since the motion is unlikely to be recognized unless the user strongly hits the pressure sensor PS with a force of the predetermined value F2 (F2=F1+Fa) or more against the pressing force Fa from the air cell AS, changing the pressing force Fa makes it possible to change the intensity of the motion requested to the user. That is, changing the pressing force Fa makes it possible to change the magnitude of the load applied to the user when the pressure sensor PS detects the motion of the user on the seat device 100. The pressing force Fa can also be set for each pressure sensor PS.

The motion determination unit 314 determines motions to be taught to the user on the seat device 100 via the output unit 22 such as the monitor 23, based on the information acquired by the information acquisition unit 310 and stored in the user information D/B 320. That is, an exercise program to be suggested is determined according to the responses to the questionnaire transmitted from the seat device 100 and the results of the preparatory exercise, and a series of motions to be taught to the user is determined. More specifically, according to conditions such as the number of motions of moving each part of the body designated by the administrator, continuity, speed, and intensity, a song of an appropriate length and speed is determined, a plurality of motions is combined according to the song, and a series of motions to be taught to the user is determined.

If it is determined that the physical condition of the user is not good based on the responses to the questionnaire transmitted from the seat device 100 and the results of the preparatory exercise, the motion determination unit 314 determines that the user is to be suggested not to perform exercise. In addition, it is determined whether any one of the pressure sensors PS and the monitor 23 has failed. If it is determined that any has failed, the motion determination unit 314 determines that the user is to be suggested not to perform exercise.

The motion evaluation unit 315 evaluates the motions of the user based on the series of motions determined by the motion determination unit 314 and taught to the user and the motions of the user detected by the pressure sensors PS on the seat device 100. That is, as illustrated in FIG. 5, a series of motions is taught to the user via the monitor 23 on the seat device 100, and the motion evaluation unit 315 evaluates the motions of the user detected by the pressure sensors PS when the user performs exercise while sitting on the seat 10.

More specifically, the motion evaluation unit 315 determines whether the pressures detected by the pressure sensors PS provided in the parts 11 to 15 of the seat 10 are equal to or greater than the predetermined value F1. When determining determined that the pressures are equal to or greater than the predetermined value F1, the motion evaluation unit 315 determines that the user has performed the motion. For example, referring to FIG. 5, at the timing when the motions of hitting the armrest part 14 with the right arm and hitting the seat cushion part 11 with the right leg is taught or before or after the timing, the motion evaluation unit 315 evaluates the motions of the user based on the pressures detected by the corresponding pressure sensors PS14R and PS11R.

That is, the motion evaluation unit 315 determines whether the taught motions have been performed, and evaluates the accuracy of each motion based on the determination results. When determining that each motion has been performed, the motion evaluation unit 315 evaluates the accuracy of each motion based on the time difference between the taught timing and the detected timing. For example, the motion evaluation unit 315 evaluates the motions of the user by, when determining that a taught motion has been performed, giving a score for each motion, making score adjustments such as deduction of points according to a time difference from the taught timing, and calculating the final score with respect to a case where all of a series of motions for one song are accurately performed without time differences as a perfect score.

In order to evaluate the motions of the user in more detail, the score for each motion may be changed between a case where the motion is detected in the detection range AR1 corresponding to the pressure sensor PSa in FIG. 3 and a case where the motion is detected in the detection range AR3 corresponding to the pressure sensor PSb. That is, if the motion is detected in the detection range AR3 corresponding to the pressure sensor PSb that is off the center of the taught part, the score for the motion may be adjusted by deduction.

The motion evaluation unit 315 further evaluates the physical condition of the user based on the evaluation results of the motions of the user. That is, the motion evaluation unit 315 evaluates the physical condition of the user based on the user information stored in the user information D/B 320. More specifically, the motion evaluation unit 315 evaluates the physical condition of the user according to the evaluation results of the motions of the user who performed the exercise program, based on the information regarding the evaluation of the physical condition after performing the exercise program from the administrator in the user information. The information on the results of evaluation by the motion evaluation unit 315 is stored in the user information D/B 320 of the server 30 and managed as a history of exercise of each user.

The information output unit 316 transmits various types of information to the seat device 100 and the administrator terminal 40. The information transmitted to the seat device 100 includes information on the detection ranges AR and the predetermined values F1 of the pressure sensors PS set by the detection range setting unit 311 and the threshold value setting unit 312, respectively, and information on the pressing forces Fa of the air cells AS set by the pressing force setting unit 313. The information transmitted to the seat device 100 also includes information on a series of motions to be taught to the user determined by the motion determination unit 314 and information on the results of evaluation by the motion evaluation unit 315. The information transmitted to the administrator terminal 40 includes information on the results of evaluation by the motion evaluation unit 315.

The information on the results of evaluation by the motion evaluation unit 315 is also stored in the user information D/B 320 of the server 30, and accumulated and managed as a history of exercise of each user. A graphical representation of an exercise history of the user stored in the user information D/B 320 can be transmitted to the administrator terminal 40 together with the latest results of evaluation by the motion evaluation unit 315.

This enables the administrator to remotely check the evaluation results of motions of the user who performed the exercise program or the like via the administrator terminal 40, and evaluate the current health condition of the user including the state of each part of the body and the overall coordination of the exercise from a professional viewpoint. The administrator can also check changes in the user's physical condition throughout the period in which the user performed rehabilitation or training, thereby to evaluate the effects of the rehabilitation or the training so far and reflect the evaluation results in the proposal of an exercise program to the user thereafter.

In this manner, in the service providing system 500 (FIG. 4), even during a period in which the user and the administrator cannot face each other, an appropriate exercise program according to the current state of the user is suggested remotely based on a proposal from the administrator. Accordingly, the user can continuously perform appropriate exercise on a daily basis, and can effectively perform rehabilitation and training. In addition, since the administrator can remotely manage the health condition of each user, it becomes easy for the administrator to take charge of many users with a small burden. In order to promote the use of the service providing system 500, when the user performs exercise and the health condition is evaluated, points that can be used for a discount of the health examination cost or the like may be granted to the user according to the contents of the exercise and the evaluation results.

The information on the results of evaluation by the motion evaluation unit 315 is also stored in the learning D/B of the server 30 and accumulated as exercise histories of users with various attributes and in various health conditions. The exercise histories of a plurality of users stored in the learning D/B can be utilized as learning data for machine learning for proposing highly effective exercise programs according to the attributes and health condition of each user.

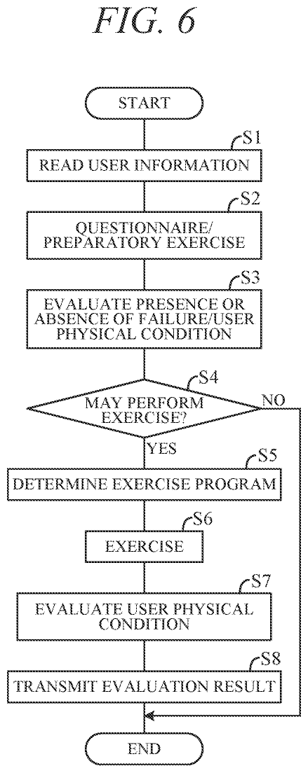

FIG. 6 is a flowchart illustrating an example of processing executed by the CPU 31 of the server 30 according to a program stored in advance. The processing illustrated in this flowchart is started when information of a request for proposal of an exercise program has been transmitted from the seat device 100, for example. As illustrated in FIG. 6, first, in step S1, the CPU 31 reads the user information including the user ID acquired via the communication unit 33. Next, in step S2, the CPU 31 reads the questionnaire and the preparatory exercise information among the user information corresponding to the user ID read in step S1 from the user information D/B 320 and transmits to the seat device 100.

When the information on responses to the questionnaire and the results of the preparatory exercise (the pressures detected by the pressure sensors PS) is transmitted from the seat device 100, the process proceeds to step S3. The CPU 31 evaluates the presence or absence of the failure of the seat device 100 and the physical condition of the user based on the responses to the questionnaire and the results of the preparatory exercise. Next, in step S4, the CPU 31 determines whether the user may perform the exercise using the seat device 100 based on the evaluation results in step S3. If the CPU 31 makes an affirmative determination in step S4, the process proceeds to step S5. If the CPU 31 makes a negative determination in step S6, the process is ended.

In step S5, the CPU 31 determines an exercise program to be suggested to the user based on the evaluation result in step S3, determines a series of motions to be taught to the user, and sets the detection ranges AR and the predetermined values F1 of the pressure sensors PS of the seat device 100 and the pressing forces Fa of the air cells AS. Next, in step S6, the CPU 31 transmits the series of motions and information of various setting values determined in step S5 to the seat device 100. When the information on the motions of the user (the detected pressures of the pressure sensors PS) detected as a result of the motions is transmitted from the seat device 100, the process proceeds to step S7.

In step S7, the CPU 31 evaluates the motions of the user based on the series of motions and various setting values determined in step S5 and the motions of the user transmitted from seat device 100, and evaluates the physical condition of the user. Next, in step S8, the CPU 31 transmits the evaluation results in step S7 to the seat device 100 and the administrator terminal 40, and stores the same in the user information D/B 320 and the learning D/B.

The operations of the service providing apparatus according to the present embodiment will be summarized below. When a user A activates and logs in the rhythm game application on the seat device 100 (FIGS. 1A and 1), the questionnaire and the instruction of the preparatory exercise from an administrator T in charge of his/her rehabilitation are displayed on the monitor 23 (steps S1 to S2). When the user A makes responses to the questionnaire and performs the preparatory exercise while sitting on the seat 10, the user can play the rhythm game along the exercise program suggested by the administrator T as illustrated in FIG. 5 (steps S3 to S6).

When the rhythm game ends, the score of the user A, the advice on the health condition of the user A from the administrator T, and the like are displayed on the monitor 23 (steps S7 and S8). The latest information regarding the health condition of the user A is transmitted to the administrator terminal 40 of the administrator T (steps S7 and S8). The administrator T can evaluate the current health condition of the user A without directly facing the user A, and can evaluate and improve the effect of the exercise program suggested to the user.

### Second Embodiment

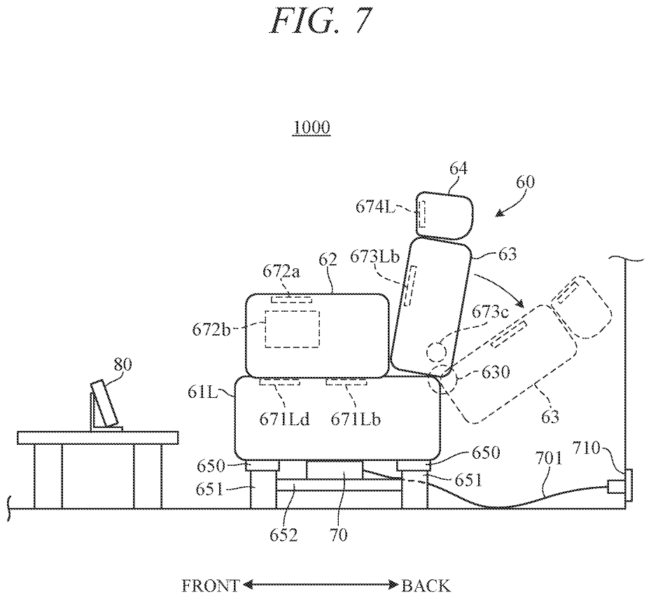

A second embodiment of the present invention will be described with reference to FIGS. 7 to 17. In relation to the first embodiment described above, the service providing apparatus that provides rehabilitation and training programs based on the health condition or the like of the user seated on the seat has been described. In relation to a second embodiment, a service providing apparatus of another form will be described. Examples of the application target include sofas and seats used in homes, offices, and the like, beds in hospitals, nursing care facilities, and the like, and seats of automobiles. These can be collectively referred to as seat. Hereinafter, the service providing apparatus in the second implementation will be described using a sofa for home as an example.

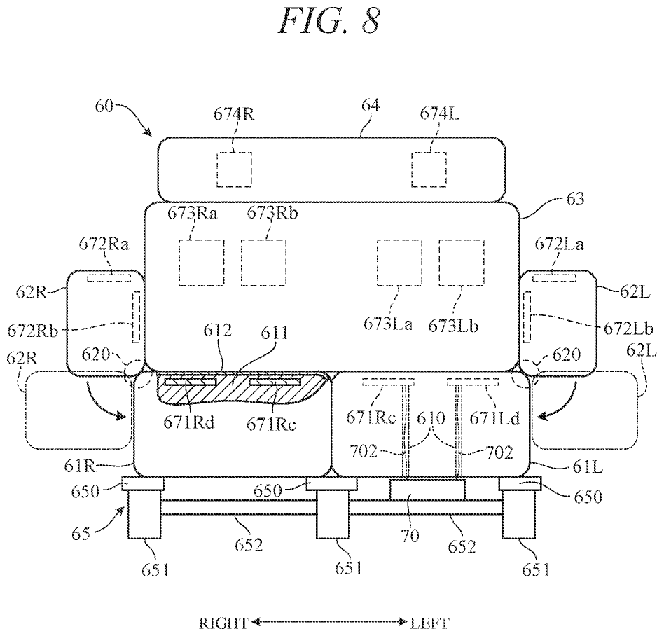

FIGS. 7 to 9 are schematic diagrams illustrating a schematic configuration of a sofa system 1000 which is an example of the service providing apparatus according to the second embodiment. FIG. 7 is a diagram illustrating an overall configuration of the sofa system 1000. As illustrated in FIG. 7, the sofa system 1000 includes a sofa 60 on which a user sits, a control device 70, and a portable information terminal 80. FIG. 8 is a front view of the sofa 60.

The sofa 60 illustrated in FIGS. 7 to 9 is a two-seat sofa, and is configured by combining a plurality of divided seat parts (seat cushions 61R and 61L, armrests 62R and 62L, a seat back 63, and a headrest 64). The armrest 62R is provided on the right side of the seat cushion 61R, and the armrest 62L is provided on the left side of the seat cushion 61L. The seat back 63 is provided on back surfaces of the pair of seat cushions 61R and 61L, and the headrest 64 is provided at an upper end of the seat back 63. The configuration of the sofa 60 is an example, and the service providing apparatus can be applied to sofas, seats, beds, and the like having various configurations.

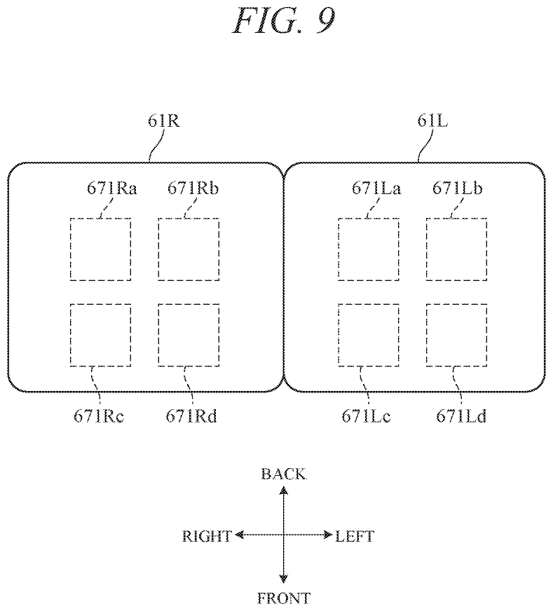

FIG. 9 is a top view of the seat cushions 61R and 61L. The seat cushion 61R is provided with four pressure sensors 671Ra to 671Rd that detect pressure from the body of the user seated on the seat cushion 61R. The seat cushion 61L is provided with four pressure sensors 671La to 671Ld that detect pressure from the body of the user seated on the seat cushion 61L. Returning to FIG. 8, pressure sensors 672Ra and 672Rb are provided on the upper surface side and the side surface on the seat cushion side of the armrest 62R. Pressure sensors 672La and 672Lb are provided on the upper surface side and the side surface on the seat cushion side of the armrest 62L.

The seat back 63 is provided with pressure sensors 673Ra and 673Rb that detect pressure from the back of the user seated on the seat cushion 61R, and pressure sensors 673La and 673Lb that detect pressure from the back of the user seated on the seat cushion 61L. The headrest 64 is provided with a pressure sensor 674R that detects pressure from the head of the user seated on the seat cushion 61R and a pressure sensor 674L that detects pressure from the head of the user seated on the seat cushion 61L.

FIG. 8 illustrates a part of the seat cushion 61R in a cross-sectional view. Each seat part constituting the sofa 60 has a frame material therein, and has a cushion material 611 such as urethane that covers the frame material and a cover material 612 such as leather or cloth that covers the cushion material. The pressure sensors 671Ra to 671Rd are arranged in an upper end region of the cushion material or between the cushion material 611 and the cover material 612. In the configuration in which the pressure sensors 671Ra to 671Rd are arranged between the cushion material 611 and the cover material 612, the cover material 612 may have four pockets, and the pressure sensors 671Ra to 671Rd may be stored in the corresponding pockets. Storing the pressure sensors 671Ra to 671Rd in the pocket prevents positional displacement of the pressure sensors 671Ra to 671Rd.

Although not illustrated, the seat cushion 61L, the armrests 62R and 62L, the seat back 63, and the headrest 64 are also provided with pressure sensors 67 (671La to 671Lc, 672Ra, 672Rb, 672La, 672Lb, 673Ra, 673Rb, 673La, 673Lb, 674R, and 674L) having the same structures. Hereinafter, the pressure sensors provided on the sofa 60 may be collectively referred to as pressure sensors 67.

The left and right armrests 62R and 62L each have a movable part 620, and can be tilted to the opposite side of the seat cushions 61R and 61L as indicated by two-dot chain lines in FIG. 8. The seat back 63 includes a movable part 630, and can be tilted toward the seat back surface side as indicated by a two-dot chain line in FIG. 7. The sofa 60 can be formed like a bed by horizontally tilting the armrests 62R, 62L and the seat back 63. For example, the seat back 63 can be adjusted to a plurality of angles including a horizontal state (at an angle of 180 degrees), and these angles are detected by an angle sensor 673c (see FIG. 7).

The pressure sensors 672Rb and 672Lb provided on the side surfaces of the armrests 62R and 62L stop the operations in the state indicated by the solid lines in FIG. 8, and are operational in the state of being tilted as indicated by two-dot chain lines.

As illustrated in FIG. 8, the seat cushions 61R and 61L are placed on a cushion support member 65. The cushion support member 65 includes a plurality of support parts 650 that support the seat cushions 61R and 61L, leg parts 651 that are provided on the support parts 650, and a coupling part 652 that couples the leg parts 651. The control device 70 is provided on the coupling part 652 and is arranged in a gap space between the coupling part 652 and the seat cushion 61L. The control device 70 may be fixed to the back surface side of the coupling part 652.

The above-described pressure sensors and angle sensor and the control device 70 are connected by harnesses 702. The harnesses 702 are routed between the cushion material 611 of the seat part and the cover material 612. For example, as illustrated in FIG. 8, a through hole 610 is formed in the cushion material 611 of the seat cushion 61L, and the harnesses 702 are arranged in the through hole 610, so that the length of the harnesses 702 can be suppressed to be short.

As illustrated in FIG. 7, the sofa system 1000 is provided with the portable information terminal 80 that functions as a remote controller of the control device 70. The portable information terminal 80 is driven by a battery, and exchanges data with the control device 70 by wireless communication. A power cable 701 of the control device 70 is connected to an outlet 710 provided in the room, so that power is supplied to the control device 70. When a power switch (not illustrated) directed to the control device 70 is turned on, the control device 70 is activated and enters a standby state to wait for an input of an ON signal from the portable information terminal 80. When an ON signal is transmitted from the portable information terminal 80 to the control device 70, the control device 70 changes from the standby state to the ON state.

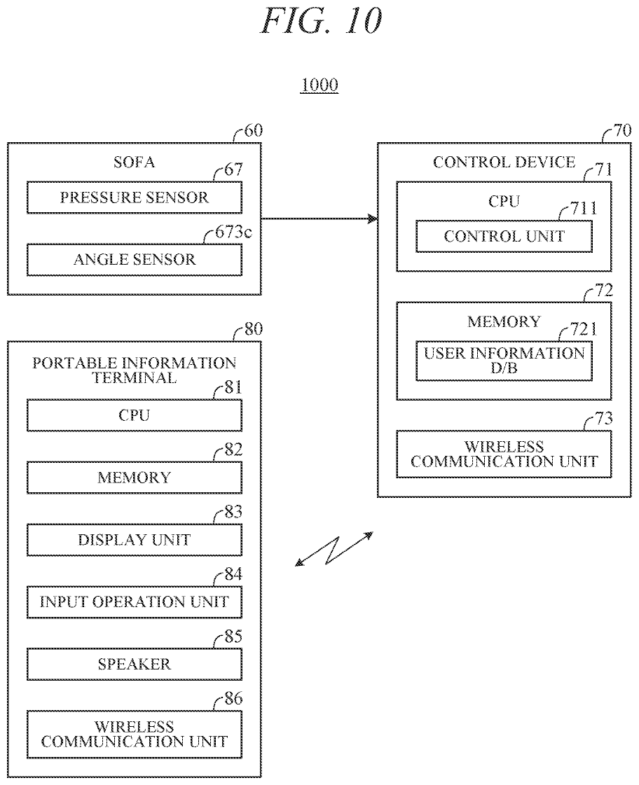

FIG. 10 is a functional block diagram of the sofa system 1000. As described above, the sofa system 1000 includes the sofa 60, the control device 70, and the portable information terminal 80. The sofa 60 includes the pressure sensors 67 and the angle sensor 673c. In the block diagram of FIG. 10, the plurality of pressure sensors 671Ra to 671Rc, 671La to 671Lc, 672Ra, 672Rb, 672La, 672Lb, 673Ra, 673Rb, 673La, 673Lb, 674R, and 674L illustrated in FIGS. 7 and 8 are collectively referred to as pressure sensor 67. Sensor information detected by the pressure sensors 67 and the angle sensor 673c is sent to the control device 70.

The control device 70 includes an electronic control unit, and includes a computer having a CPU 71, a memory 72 such as a ROM and a RAM, a wireless communication unit 73, and other peripheral circuits. A control unit 711 of the CPU 71 controls the sofa 60 based on the control software and control data stored in the memory 72, the sensor information from the sofa 60, and the information received from the portable information terminal 80. The memory 72 stores a database 721 related to user information. The wireless communication unit 73 exchanges information with a wireless communication unit 86 of the portable information terminal 80 by wireless communication. FIG. 10 illustrates transmission and reception of information by wireless communication, but wired communication may be performed.

The portable information terminal 80 includes a CPU 81, a memory 82, a display unit 83, an input operation unit 84, a speaker 85, a wireless communication unit 86, and the like. The CPU 81 executes remote controller software stored in the memory 82. The display unit 83 includes a liquid crystal display device. The input operation unit 84 is an operation unit that performs an input operation to the portable information terminal 80. If a liquid crystal display device capable of performing an input operation by a touch operation is used as the liquid crystal display device described above, the liquid crystal display device functions as the display unit 83 and also functions as the input operation unit 84 that is capable of inputting information by a displayed operation icon. Herein, the input operation unit 84 includes both a physical operation switch and an operation icon displayed on the display unit 83 described above. For example, there is a power switch for turning on and off the portable information terminal 80. The physical operation switch of the input operation unit 84 corresponds to the power switch.

The sofa system 1000 of the present embodiment has service functions (modes) as described below. Selection of the service function is performed on the portable information terminal 80.

(Play Mode)

In a play mode, the plurality of pressure sensors 67 provided on the sofa 60 is used to provide piano play, place guessing game, drumming play, and the like. Selection among piano play, place guessing game, and drumming is performed by the portable information terminal 80. In the play mode, the armrests 62R and 62L and the seat back 63 of the sofa 60 are laid down so that the sofa 60 is formed into a bed.

In the piano play, the 12 pressure sensors positioned on the upper surface of the bed form are grouped into eight sensor groups of (674R), (674L), (673Ra and 673Rb), (673La and 673Lb), (672Rb), (671Ra to 671Rd), (671La to 671Ld), and (672Lb), and sounds of C, D, E, F, G, A, B, and C are sequentially assigned. When the user hits or presses a place where any of the sensor groups is provided, a sound corresponding to the sensor group is generated from the speaker 85 of the portable information terminal 80. The control unit 711 of the control device 70 determines which sensor group has been hit based on the sensor information from the pressure sensor 67. The determination result is transmitted from the control device 70 to the portable information terminal 80. The portable information terminal 80 causes the speaker 85 to generate a corresponding sound based on the received determination result.

In the place guessing game, only one of the above-described eight sensor groups is set such that a sound is output from the speaker 85 when the sensor group is pressed or hit. The portable information terminal 80 randomly selects the sensor group set to emit a sound. For example, when an operation icon called select displayed on the display unit 83 is displayed and the user presses the icon, a sensor group to emit a sound is selected. The user searches for the place of the sensor group to emit a sound, by hitting or pressing the sofa 60. The control unit 711 of the control device 70 determines which sensor group has been pressed based on the sensor information from the pressure sensor 67. Then, if the determined sensor group is identical to the sensor group selected by the portable information terminal 80, an identity signal indicating the identity is transmitted to the portable information terminal 80. Upon receiving the identity signal, the portable information terminal 80 outputs the sound assigned to the sensor group from the speaker 85.

In the drumming play, the pressure sensors 674R and 674L provided in the headrest 64 are used, for example. Each of the pressure sensors 674R and 674L is associated with a sound of a drum, for example, a sound of a conga. When the user hits the places of the pressure sensors 674R and 674L, the information is transmitted from the control device 70 to the portable information terminal 80, and the sounds of the drum corresponding to the hit pressure sensors are output from the speaker 85 of the portable information terminal 80.

(Exercise Mode)

In the exercise mode, support is provided to the user who performs exercise on the sofa 60. For example, the number of sit-ups made by the user is counted and stored. The number of sit-ups is counted by counting the number of times the pressure sensors 673Ra, 673Rb, 673La, and 673Lb provided in the seat back 63 are pushed by the back of the user. The count data is stored in the database 721 of the control device 70 as a set with the angle of the seat back 63 detected by the angle sensor. In order to use the exercise mode, the user operates the portable information terminal 80 to input his/her user ID. The count data is stored in association with the user ID.

(Posture Diagnosis Mode)

A posture diagnosis mode is mode A for evaluating the posture of the user seated on the sofa 60. For example, when the user sits on the seat cushion 61R of the sofa 60, pressure according to the posture of the user is applied to the pressure sensors 671Ra to 671Rd provided in the seat cushion 61R, the pressure sensors 673Ra and 673Rb provided in the seat back 63, and the pressure sensor 674R in the headrest 64.

The control unit 711 of the control device 70 estimates the posture of the user based on the sensor information. Then, the control unit 711 compares the estimated posture of the user with the ideal posture stored in advance in the memory 72, and calculates the front-back direction adjustment amount of the seating position and the adjustment amount of the inclination of the upper body in the front-back direction. The control unit 711 transmits a seating position adjustment signal and an inclination adjustment signal to the portable information terminal 80 based on the calculated adjustment amounts. The seating position adjustment signal is signal indicating whether the adjustment direction is forward or backward in the front-rear direction. The inclination adjustment signal is signal indicating whether the adjustment direction of the inclination of the upper body is forward or backward. Upon receiving the seating position adjustment signal and the inclination adjustment signal from the control device 70, the portable information terminal 80 displays an icon representing the direction in which the seating position is to be adjusted and an icon representing the direction in which the inclination of the upper body is to be adjusted on the display unit 83. If the calculated adjustment amounts of the seating position and inclination are smaller than predetermined threshold amounts, the control unit 711 determines that the posture is close to the ideal posture, and transmits an OK signal to the portable information terminal 80.

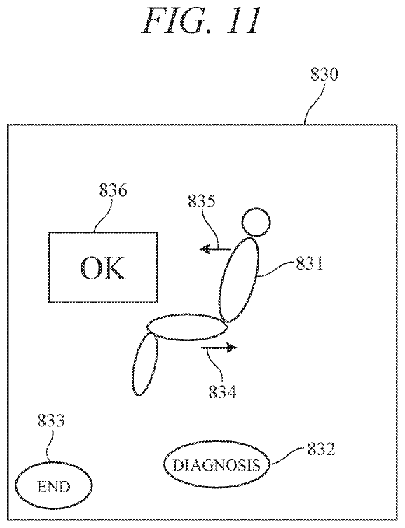

FIG. 11 is a diagram illustrating a display example on the display unit 83 in the posture diagnosis mode. When the posture diagnosis mode is selected, an icon 831 representing a seated posture, a diagnosis icon 832 for starting diagnosis and an end icon 833 for ending the posture diagnosis mode are displayed on the display screen 830 of the display unit 83. When the diagnosis icon 832 is touched, a diagnosis start signal is transmitted from the portable information terminal 80 to the control device 70, and diagnosis processing is executed. When the seating position adjustment signal and the inclination adjustment signal are received from the control device 70, arrow icons 834 and 835 indicating the adjustment directions are displayed. When the portable information terminal 80 receives the OK signal, an OK icon 836 indicating OK is displayed.

The arrow icons 834 and 835 illustrated in FIG. 11 indicate that the upper body is to be adjusted in the forward direction and the seating position is to be adjusted in the backward direction. When the adjustment directions are opposite, the directions of the arrow icons 834 and 835 are also opposite. If the user having adjusted his/her posture wishes to perform diagnosis again, the user touches on the diagnosis icon 832. As a result, the posture diagnosis processing is executed again, and the diagnosis result after the posture adjustment is displayed on the display screen 830. When an OK signal is received from the control device 70, an OK icon 836 is displayed instead of the arrow icons 834 and 835.

A body weight measuring function may be added to the posture diagnosis mode, so that the body weight of the seated user may be calculated using the sensor information from the pressure sensors 671Ra to 671Rd provided in the seat cushion 61R, and the calculation result may be displayed on the display unit 83. In order to measure the weight, an instruction for the user to raise both legs and raise the upper body from the seat back is displayed on the display unit 83. Then, the control unit 711 calculates the weight based on the sensor information from the pressure sensors 671Ra to 671Rd in the posture state, and transmits the calculation result to the portable information terminal 80.

[Control Example]

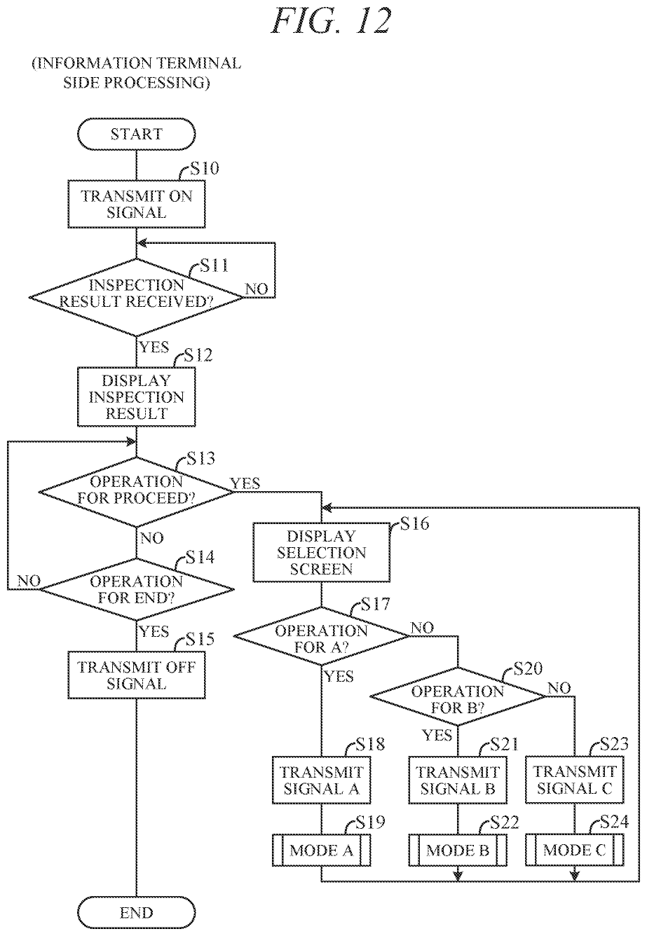

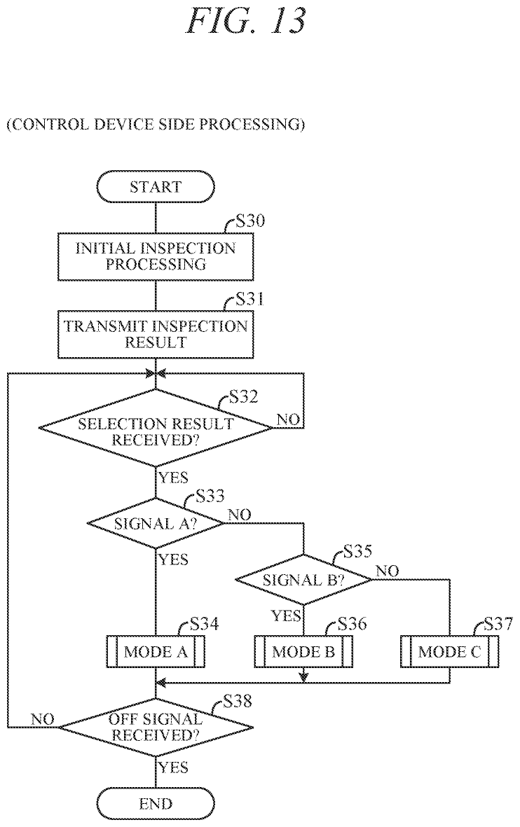

Next, control operations of the portable information terminal 80 and the control device 70 in a case where the above-described service functions are provided will be described. FIG. 12 is a flowchart of control operations of the portable information terminal 80 (CPU 81), and FIG. 13 is a flowchart of control operations of the control device 70 (control unit 711). The portable information terminal 80 and the control device 70 perform control processing in parallel while transmitting and receiving signals to and from each other. Hereinafter, the controls in the flowcharts of FIGS. 12 and 13 performed in parallel will be described in order according to the flow of processing.

First, when the user powers on the portable information terminal 80, the processing in the flowchart of FIG. 12 is started. In step S10 of FIG. 12, the portable information terminal 80 transmits an ON signal for turning the control device 70 from the standby state to the ON state to the control device 70.

When the control device 70 receives the ON signal from the portable information terminal 80, the control unit 711 of the control device 70 starts the processing in the flowchart of FIG. 13. In step S30 of FIG. 13, the control unit 711 executes an initial inspection process of the sofa 60. The initial inspection process is a process of inspecting whether the pressure sensors 67 and the angle sensor 673c are normally functioning. For example, if a sensor signal is normally input from each sensor, it is determined that the sensors are normal, and if no signal is input from any sensor, it is determined that the sensor is anomalous. In step S31, the inspection result of the initial inspection process is transmitted to the portable information terminal 80.

Step S11 of FIG. 12 is a step of determining whether the inspection result of the initial inspection process has been received, and if the inspection result has been received, the process proceeds to step S12. In step S12, the received inspection result is displayed on the display unit 83 of the portable information terminal 80. In the event of an anomaly, a warning sound may be emitted from the speaker 85 together with anomaly display. Displayed on the display screen of the display unit 83 are the inspection result, an icon to proceed to the next step, and an icon to end the process. The user determines whether to proceed to the next step or end the process based on the inspection result, and performs a touch operation on the proceed icon or the end icon.

In step S13 of FIG. 12, it is determined whether a touch operation has been performed on the icon to proceed to the next step. If the touch operation has been performed, the process proceeds to step S16, and if a negative determination is made, the process proceeds to step S14. In step S14, it is determined whether a touch operation has been performed on the end icon. If the touch operation has been performed, the process proceeds to step S15, and if a negative determination is made, the process returns to step S13. If the touch operation has been performed on the end icon and the process has proceeded from step S14 to step S15, an off signal is transmitted to the control device 70, and the control process in FIG. 12 is ended.

On the other hand, if the touch operation has been performed on the proceed icon and the process has proceeded from step S13 to step S16, in step S16, a selection screen for selecting one of the posture diagnosis mode, the exercise mode, and the play mode is displayed on the display unit 83, and the process waits for the user's operation. Displayed on the selection screen are an icon A for selecting the posture diagnosis mode, an icon B for selecting the motion mode, and an icon C for selecting the play mode.

In step S17, it is determined whether a touch operation has been performed on the icon A. If the touch operation has been performed on the icon A, the process proceeds from step S17 to step S18, and a signal A is transmitted to the control device 70 in step S18. Next, the process proceeds to step S19, and a series of processes for the posture diagnosis mode (mode A) is executed on the portable information terminal 80.

If a negative determination is made in step S17, the process proceeds to step S20, and it is determined whether the touch operation has been performed on the icon B. If the touch operation has been performed on the icon B, the process proceeds from step S20 to step S21, and a signal B is transmitted to the control device 70 in step S20. Next, the process proceeds to step S22, and a series of processes for the exercise mode (mode B) is executed on the portable information terminal 80.

If a negative determination is made in step S20, the process proceeds to step S23, and a signal C is transmitted to the control device 70 in step S23. Next, the process proceeds to step S24, and a series of processes for the play mode (mode C) is executed on the portable information terminal 80.

On the other hand, in step S32 in FIG. 13, it is determined whether a selection result signal (any of signals A to C) has been received from the portable information terminal 80, and if any has been received, the process proceeds to step S33. In step S33, it is determined whether the received selection result signal is the signal A. If the received selection result signal is the signal A, the process proceeds to step S34, and a series of processes for the posture diagnosis mode (mode A) is executed on the control device 70. Thereafter, the process proceeds to step S38.

If a negative determination is made in step S33, the process proceeds to step S35, and it is determined whether the selection result signal received in step S35 is the signal B. If it is determined in step S35 that the received signal is the signal B, the process proceeds to step S36 to execute a series of processes for the motion mode (mode B) on the control device 70, and then the process proceeds to step S38. On the other hand, if a negative determination is made in step S35, the process proceeds to step S37 to execute a series of processes for the play mode (mode C) on the control device 70, and then the process proceeds to step S38.

In step S38, it is determined whether an OFF signal has been received from the portable information terminal 80. If the OFF signal has not been received, the process returns to step S32, and the reception determination process on the selection result signal is performed again. On the other hand, if the termination operation was performed by the portable information terminal 80 and the OFF signal was transmitted in step S15 of FIG. 12, it is determined in step S38 of FIG. 13 that the OFF signal has been received, a series of processes on the control device 70 is terminated, and the control device 70 enters a standby state.

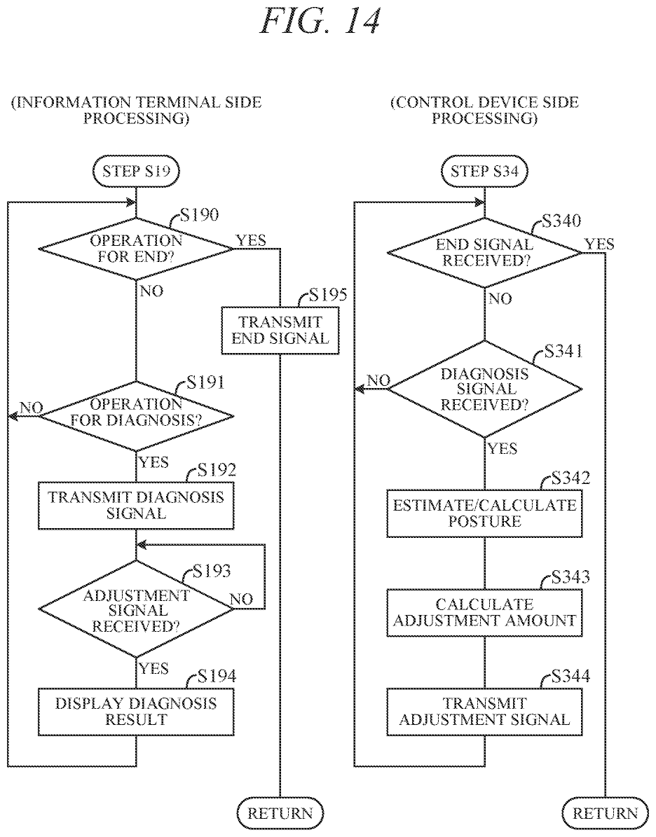

FIG. 14 is a diagram illustrating an example of a posture diagnosis mode (mode A) processing routine in step S19 of FIG. 12 and a posture diagnosis mode (mode A) processing routine in step S34 of FIG. 13. Detailed processing operations in steps S22 and S24 in FIG. 12 and steps S36 and S37 in FIG. 13 will not be described. In FIG. 14, the flowchart on the left side in the drawing illustrates the processing routine in step S19 on the information terminal 80, and the flowchart on the right side in the drawing illustrates the processing routine in step S34 on the control device 70. Herein, a case where the user is seated on the seat cushion 61R of the sofa 60 will be described as an example.

When the process proceeds to step S19 in FIG. 12, it is determined in step S190 in FIG. 14 whether the end icon 833 (see FIG. 11) on the display screen 830 has been operated. If the user has performed a touch operation on the end icon 833, the process proceeds from step S190 to step S195, and an end signal is transmitted to the control device 70. Thereafter, the processing routine in step S19 is ended, and the process proceeds to step S16 in FIG. 12. If a negative determination is made in step S190, the process proceeds to step S191, and it is determined whether the diagnosis icon 832 on the display screen 830 has been operated. If the user has performed a touch operation on the diagnosis icon 832, the process proceeds from step S191 to step S192. If a negative determination is made, the process returns to step S190. In step S192, a diagnosis signal is transmitted to the control device 70. Next, the process proceeds to step S193, and it is determined whether an adjustment signal has been received from the control device 70. That is, the control device 70 waits for transmission of the adjustment signal.

On the other hand, in step S340 on the control device 70, it is determined whether an end signal ordering the end of the posture diagnosis mode has been received from the portable information terminal 80. If the end signal has been received, the posture diagnosis processing routine in step S34 is ended, and the process proceeds to step S38 in FIG. 13. If a negative determination is made in step S340, the process proceeds to step S341 to determine whether a diagnosis signal has been received from the portable information terminal 80. When the diagnosis signal is transmitted from the portable information terminal 80 in step S192 described above, it is determined in step S341 on the control device 70 that the diagnosis signal has been received, and the process proceeds to step S342. On the other hand, if a negative determination is made in step S341, the process returns to step S340.

In step S342, the control unit 711 estimates the posture of the user based on the detection results from the pressure sensors 671Ra to 671Rd. In step S343, the control unit 711 compares the posture of the user estimated in step S342 with the ideal posture stored in advance in the database 721, and calculates the front-back direction adjustment amount of the seating position and the adjustment amount of the inclination of the upper body in the front-back direction. In step S344, adjustment signals (the seating position adjustment signal and the inclination adjustment signal) related to the front-rear direction adjustment amount of the seating position and the adjustment amount of the inclination of the upper body in the front-rear direction calculated in step S343 are transmitted to the portable information terminal 80. The seating position adjustment signal and the inclination adjustment signal are signals indicating a direction forward or backward of the current position. When the posture diagnosis result is OK, an OK signal is transmitted as an adjustment signal. When step S344 is completed, the process returns to step S340.

When the portable information terminal 80 receives the adjustment signal from the control device 70, an affirmative determination is made in step S193, and the process proceeds to step S194. In step S194, a diagnosis result as illustrated in FIG. 11 is displayed based on the received adjustment signal. On the display screen 830, arrow icons 834 and 835 and an OK icon 836 are displayed based on the diagnosis result. When step S194 is ended, the process returns to step S190.

As described above, the sofa system 1000 has a plurality of service functions of one sofa 60, and can provide various services based on the sensor information from the pressure sensors 67 provided on the sofa 60.

In relation to the second embodiment, the household sofa 60 has been described as an example. However, the same configuration as described above can also be applied to a care bed, an automobile seat, and the like. As in the first embodiment, a pressing unit (air cell AS) may be provided and operated based on sensor information from the pressure sensors 67.

(Other Service Functions)

At a furniture store, pressure sensors may be set in sofas or the like on display, and a service for proposing sofas or chairs with comfortable seats suitable for customers may be provided using information from the pressure sensors.

In the example of the furniture store described above, the pressure sensor information may be transmitted from a plurality of stores to the management server via the Internet, and the situation of customers' usage at each store may be grasped. For example, the pressure sensor information can be used for analysis of a product on which customers have seated a large number of times.

The pressure sensors can be set in beds at hospitals, nursing care facilities, or the like to check the state of patients' rolling over for preventing pressure ulcers. Humidity sensors or temperature sensors may be provided to visualize the amount of night sweat (display of the timing of changing clothes or lack of moisture).

The numbers of times customers have seated on purchased sofas or the like may be counted at the stores via the Internet, and points may be granted to the customers according to the number of times. The points can also be useful for sales promotion by performing cashback or the like according to the points at the time of repurchase. Since the lifetime of a sofa depends on the number of times of seating, encouraging the users to seat a large number of times by giving points may shorten a repurchase cycle, which leads to sales promotion.

(Arrangement of Pressure Sensors 67)

As described above, in the sofa system 1000 of the present embodiment, the pressure sensors 67 and the angle sensor 673c that detect physical actions of the user seated on the sofa 60 are provided, and various services are provided based on the sensor information. Therefore, in order to provide appropriate services, it is necessary to ensure the detection accuracy of the pressure sensors 67.

The sofa 60 illustrated in FIGS. 7 to 9 is a sofa having a general configuration, and is configured by combining the plurality of divided seat parts (seat cushions 61R and 61L, armrests 62R and 62L, seat back 63, and headrest 64). As illustrated in FIGS. 7 and 8, the movable parts 620 and 630 are provided to adjust the inclinations of the armrests 62R and 62L and the seat back 63.

In the edge region of the seat part, the cushion material 611 is often deformed due to an influence of a hanging part of the cover material 612 or the like. Since the movable parts 620 and 630 are provided in the edge region where the seat part and the seat part are connected, the cushion material 611 in the edge region becomes deformed with the movement of the movable parts. Therefore, if the pressure sensors 67 are arranged at positions in the edge region of the seat part or at positions close to the edge region, the detection values are easily affected by the deformation of the cushion material 611. Therefore, from a viewpoint of ensuring the detection accuracy, the pressure sensors 67 are preferably disposed apart from the edge region of the seat part.

In a seat for an automobile, the seat part may include a heater, a blower that blows air-conditioned air, and the like. In such a case, if the pressure sensors 67 are arranged at positions overlapping or close to the heater or the blower, the detection accuracy of the pressure sensors 67 are adversely affected by the temperature change due to the heater or the air-conditioned wind. Therefore, the pressure sensors 67 are preferably disposed at positions away from the heater or the blower.

On the other hand, if the seat part is provided with an elastic support material such as a coil spring that supports the seating surface, the pressure sensors 67 are preferably disposed in the seating area supported by the elastic support material. With such a configuration, the pressure sensors 67 are stably supported by the elastic support material, and the detection accuracy of the pressure sensors 67 can be improved. In general, since the seating area is disposed in the central area of the seat part, the pressure sensors 67 are preferably arranged in the central area separated from the edge region of the seat part.

(Modification of Sofa 60)

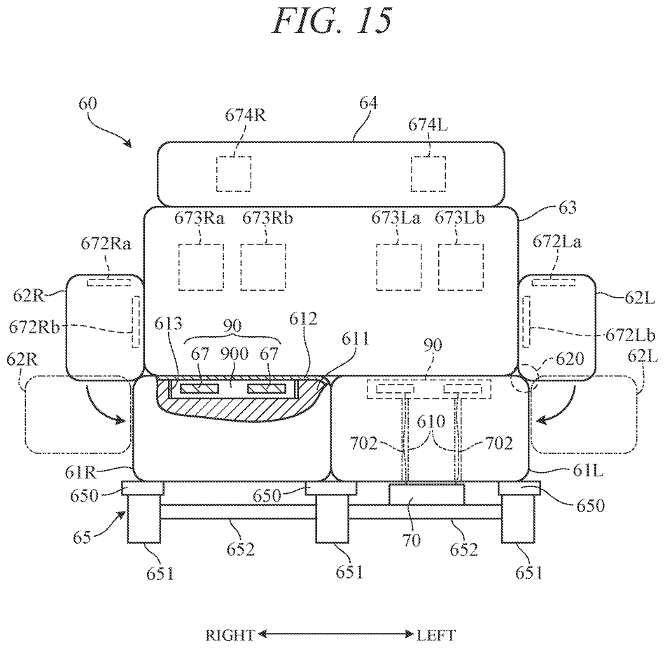

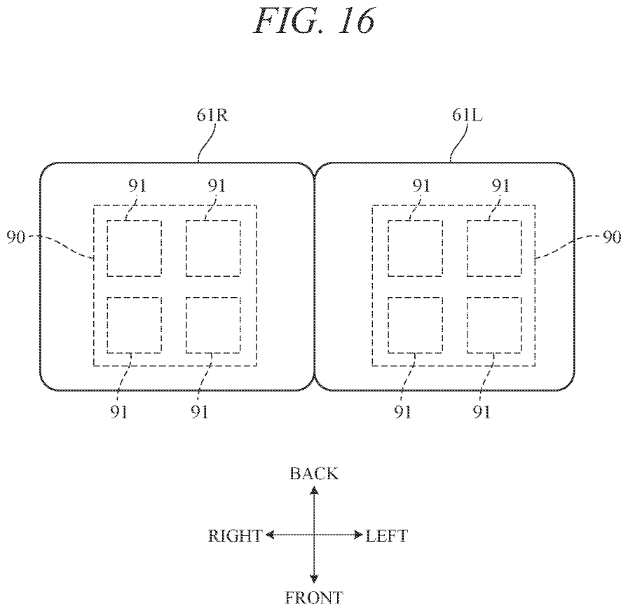

FIGS. 15 and 16 are diagrams illustrating a modification of the sofa 60. In the sofa 60 of the modification, pressure sensors 67 are provided on seat pads 90 arranged in a recess 613 of a cushion material 611 of the sofa 60. FIGS. 15 and 16 illustrate the seat pads 90 are illustrated only in seat cushions 61R and 61L. However, other pressure sensors 67 are also provided on the seat pads.

Each seat pad 90 has four pressure sensors 67 inside a cushion material 900 in a cover (not illustrated). Of course, the cushion material 900 may be omitted, and the four pressure sensors 67 may be directly arranged in the cover. If any of the pressure sensors 67 fails, it is only necessary to remove the pad 90 from the recess 613 and replace the pad with normal seat pads 90. This has an advantage that the repair cost is low as compared with a configuration in which the pressure sensors 67 are directly arranged on the cushion material 611 of the sofa 60.

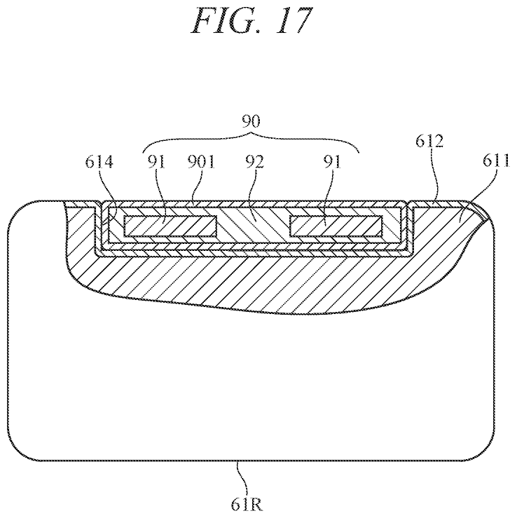

As illustrated in FIG. 17, a recess 614 may be formed in the upper surface of the seat cushion 61R covered with a cover material 612, and the seat pad 90 may be arranged in the recess 614. The pressure sensor 91 provided on the seat pad 90 is disposed in the cushion material 900, and the cushion material 900 is covered with the cover material 901. Of course, the cushion material 900 may be omitted, and the pressure sensors 91 may be directly arranged on the cover material 901. In the configuration illustrated in FIGS. 15 and 16, the seat pad 90 cannot be replaced without removing the cover material 612 of the seat cushion 61R from the cushion material 611. However, in the configuration illustrated in FIG. 17, the seat pad 90 can be replaced only by removing the seat pad 90 from the recess 614 of the seat cushion 61R.

According to the embodiments and the modifications of the present invention described above, the following operations and advantageous effects can be achieved.

(1) As illustrated in FIG. 10, the service providing apparatus includes: the pressure sensors 67 that are provided on the sofa 60 as a seat and detect a motion of a user seated on the sofa 60; the control device 70 that has a plurality of service functions (posture diagnosis mode, play mode, and exercise mode) and determines service contents in the plurality of service functions according to detection results from the pressure sensors 67; and the display unit 83 and the speaker 85 that present the service contents determined by the control device 70. Since the user is provided with the plurality of service functions (posture diagnosis mode, play mode, and exercise mode), the user can play a game or diagnose his/her posture by sitting on the sofa 60 or pressing or hitting each part of the sofa 60.

(2) The service providing apparatus includes: the pressure sensors PS that are provided on the seat 10 and detect a motion of a user seated on the seat 10; the motion determination unit 314 that determines a motion to be taught to the user seated on the seat 10; the output unit 22 that teaches the motion determined by the motion determination unit 314 to the user seated on the seat 10, the motion evaluation unit 315 that evaluates the motion of the user seated on the seat 10 based on the motion determined by the motion determination unit 314 and the motion detected by the pressure sensors PS; and an information output unit 316 that outputs information of an evaluation result from the motion evaluation unit 315 (FIG. 4).

The motion determination unit 314 determines a motion to be taught to the user seated on the seat 10, based on user information including information of a request for a proposal of an exercise program from the user seated on the seat 10. That is, changing the contents of an application such as a rhythm game according to the evaluation result of the motion of the user makes it possible to suggest an appropriate exercise to be performed in a seated state according to the state of the user.

Each pressure sensor PS detects a pressure that is a physical quantity having a correlation with a force exerted on the seat 10 from the user seated on the seat 10. The motion evaluation unit 315 determines whether the pressure detected by the pressure sensor PS is equal to or greater than the predetermined value F1. When determining that the pressure is equal to or greater than the predetermined value F1, the motion evaluation unit 315 determines that the motion of the user seated on the seat 10 has been detected by the pressure sensor PS. The service providing apparatus further includes the threshold value setting unit 312 that sets the predetermined value F1 based on the user information (FIG. 4). This makes it possible to change the load of the exercise performed in the sitting state according to the current state of the user such as the purpose of the exercise, the age, and the physical condition of that day.

(3) The motion evaluation unit 315 further evaluates the physical condition of the user seated on the seat 10 based on the evaluation result of the motion of the user seated on the seat 10. For example, the motion evaluation unit 315 evaluates the physical condition of the user according to the evaluation result of the motion of the user based on criteria predetermined by the administrator. Accordingly, the current health condition of the user can be evaluated from a professional viewpoint.

(4) The motion determination unit 314 determines that no motion is to be taught by the output unit 22 according to the evaluation result from the motion evaluation unit 315. That is, if it is determined that the physical condition of the user is not good or if it is determined that any of the pressure sensors PS and the monitor 23 is broken, it is possible to suggest the user not to perform exercise on the seat device 100.

(5) The service providing apparatus further includes the air cells AS that are provided on the seat 10 and press the user seated on the seat 10, and the pressing force setting unit 313 that sets the pressing force Fa of each air cell AS based on the user information (FIG. 4). The pressing force Fa by the air cell AS in accordance with the current state of the user can be changed to increase the load of the exercise performed in the seated state.

(6) The service providing apparatus further includes the detection range setting unit 311 that sets the detection ranges AR in which the motion of the user seated on the seat 10 is detected by the pressure sensors PS on the seating surface 10a of the seat 10 based on the user information (FIG. 4). The detection ranges AR according to the current state of the user can be changed to change the accuracy of the exercise to be performed in the seated state requested to the user. Alternatively, the motion of the user can be evaluated in more detail by changing the evaluation values of the motion of the user according to the detection ranges AR.

(7) The output unit 22 is at least one of the speaker 24 that provides teaching by voice, the monitor 23 or the indicator that provides teaching by display, and the vibrator that provides teaching by vibration (FIG. 4). This allows the user to select the content of the service application or the teaching mode that is easy for the user to recognize.

(8) The motion determination unit 314 determines whether any of the pressure sensors PS and the output unit 22 has failed. If determining that any one of the pressure sensors PS and the output unit 22 has failed, the motion determination unit 314 determines that no motion is to be taught by the output unit 22. This prevents the user from performing exercise using the seat device 100 in which any of the pressure sensors PS or the like is broken.

(9) The plurality of pressure sensors PS is provided in correspondence with a plurality of parts of the body of the user seated on the seat 10 (FIGS. 1A and 1). The motion determination unit 314 determines motions including a motion of each part of the body of the user seated on the seat 10. Accordingly, it is possible to suggest to the user a series of motions in which a plurality of motions of moving the parts of the body is combined as an exercise program in accordance with one song, for example.

(10) The motion determination unit 314 determines timing for motion to be taught to the user seated on the seat 10. The output unit 22 teaches the user seated on the seat 10 the timing for the motion determined by the motion determination unit 314. The motion evaluation unit 315 evaluates the motion of the user seated on the seat 10 based on the time difference between the timing for the motion determined by the motion determination unit 314 and the timing with which the motion was detected by the pressure sensor PS. By evaluating the accuracy of each motion based on the time difference between the timing at which each motion was taught and the timing at which each motion was actually detected, it is possible to evaluate the health condition of the user including the state of each part of the body and the overall coordination of the exercise from a professional viewpoint.

In relation to the first embodiment, the pressure sensors PS built in the main body of the seat 10 are illustrated in FIGS. 1A, 1, and others. However, the motion detection unit that detects the motion of the user seated on the seat is not limited to the pressure sensors PS. For example, the motion detection unit may be provided on a seat cover that is placed on the seating surface of a seat on which a user sits and is detachable from the seat main body, or the motion detection unit may be a sensor or a switch that detects a physical quantity other than pressure.

In relation to the first embodiment, a specific shape of the seat 10 is illustrated in FIGS. 1A and 1B. However, the seat is not limited to the illustrated shape. For example, the seat may not include a seat back part, a headrest part, an ottoman part, an armrest part, and the like. The seat may be a foldable simple chair or the like.

In the first embodiment, an exercise program or the like is suggested in advance by the administrator and motions to be taught to the user are determined based on the exercise program or the like. However, the motion determination unit is not limited to such a configuration. For example, the user and the administrator may meet online via the service providing system 500 and then may perform a questionnaire and a preparatory exercise. Even in this case, the administrator can not only check the state of the user by video or voice, but also check the evaluation results based on the pressure detected during the preparatory exercise. Therefore, the administrator can suggest an appropriate exercise program.

In the first embodiment, one user plays a rhythm game using one seat device 100 as illustrated in FIGS. 1A and 1B. However, a plurality of users may play a rhythm game together using a plurality of seat devices 100. The user may play a rhythm game together with another user who uses a controller other than the seat device 100.

In the first embodiment, the seat device 100 is used as a controller to execute a rhythm game application. However, the service application to which the service providing apparatus is applied is not limited to the rhythm game.

In the first embodiment, a motion is taught to the user by the screen display of the monitor 23 as illustrated in FIG. 5 and the like. However, the motion teaching unit that teaches the motion to the user is not limited to such a configuration. For example, a motion may be taught by designating a place to be hit, by a voice instruction issued from a speaker such as “right arm”. Alternatively, a motion may be taught by providing a vibrator that generates vibration corresponding to the arrangement position of the sensor, an indicator that lights up corresponding to the arrangement position of the sensor, or the like to designate the place to hit by the vibration or lighting.

(11) In the above (1), as illustrated in FIGS. 10 and 11, the pressure sensors 67 are provided to detect a physical quantity having a correlation with a force exerted on the sofa 60 by the user seated on the sofa 60, and the user selects any one of a plurality of service functions by performing a touch operation on an icon displayed on the display unit 83 of the portable information terminal 80. The portable information terminal 80 exchanges information with the control device 70 via communication. In this way, the user seated on the sofa 60 can use a plurality of service functions.

(12) In the above (11), the plurality of service functions includes the posture diagnosis service function of diagnosing the seating posture of the user seated on the sofa 60, the control unit 711 of the control device 70 performs posture diagnosis of the user seated on the sofa 60 based on the detection results from the pressure sensors 67, and the portable information terminal 80 exchanges information with the control device 70 via communication and displays the diagnosis results on the display unit 83. The user can diagnose the sitting posture only by seating on the sofa 60, and can view the diagnosis results on the portable information terminal 80 at hand.

(13) In the above (12), the control device 70 performs anomaly diagnosis of the pressure sensors 67 in addition to the posture diagnosis. If the control device 70 diagnoses that any of the pressure sensors 67 is anomalous, the display unit 83 and the speaker 85 output anomaly indication and a warning sound as anomaly information. As a result, the user can recognize the anomaly of the pressure sensor 67.

(14) In the above (11), the sofa 60 includes the plurality of divided seat parts (the seat cushions 61R and 61L, the armrests 62R and 62L, the seat back 63, and the headrest 64), and the pressure sensors 67 are arranged away from the edge region of the seat parts. Arranging the pressure sensors 67 apart from the edge regions of the seat parts makes it possible to suppress the influence of the hanging part and the movable part provided in the edge region and to improve the detection accuracy of the pressure sensors 67.

(15) In the above (11), as illustrated in FIG. 17, the seat pads 90 attachable to and detachable from the sofa 60 are further provided, and the pressure sensors 91 are provided on the seat pads 90, not on the sofa 60. Providing the detachable seat pads 90 makes it possible to improve work efficiency in replacing the pressure sensors 91.

(16) In the above (11), as illustrated in FIGS. 7 and 8, disposing the control device 70 on the back surface of the seat opposite to the seating surface of the sofa 60 makes it possible to avoid upsizing of the sofa 60 due to the provision of the control device 70.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

10 seat; 11 seat cushion part; 12 seat back part; 13 headrest part; 14 armrest part; 15 ottoman part; 16 seat frame; 17 cushion material; 18 seat cover; 19 controller; 20 user terminal; 21 input unit; 22 output unit; 23 monitor; 24; 85 speaker; 31; 42; 190 CPU; 32; 43; 191 memory; 33; 44; 192 communication unit; 41 input/output unit; 60 sofa; 67; PS pressure sensor; 80 portable information terminal; 83 display unit; 84 input operation unit; 70 control device; 90 seat pad; 100 seat device; 310 information acquisition unit; 311 detection range setting unit; 312 threshold value setting unit; 313 pressing force setting unit; 314 motion determination unit; 315 motion evaluation unit; 316 information output unit; 320 user information D/B; 321 learning D/B; 500 service providing system; 1000 sofa system; AS air cell

1. A service providing apparatus, comprising:
a detector provided on a seat and configured to detect a motion of a user seated on the seat;
a control device including a processor and a memory coupled to the processor, having a plurality of service functions and configured to determine a service content in the plurality of service functions based on the motion detected by the detector; and
a presentation unit configured to present the service content determined by the control device.

2. The service providing apparatus according to claim 1, wherein
the control device is further configured to:
determine a target motion to be taught to the user; and
evaluate the motion of the user based on the target motion and the motion detected by the detector, wherein
the presentation unit includes:
an information output unit configured to output the target motion and an evaluation result of the motion of the user; and
a motion teaching unit configured to teach the target motion to the user, wherein
the control device determines the motion to be taught to the user based on user information including an operation request command from the user, wherein
the detector detects a physical quantity having a correlation with a force exerted on the seat by the user, wherein
the control device determines whether the physical quantity detected by the detector is equal to or greater than a threshold value, and determines that the detector has detected the motion of the user when it is determined that the physical quantity is equal to or greater than the threshold value, wherein
the control device is further configured to set the threshold value based on the user information.

3. The service providing apparatus according to claim 2, wherein
the control device further evaluates a physical condition of the user based on the evaluation result of the motion of the user.

4. The service providing apparatus according to claim 3, wherein
the control device determines that no target motion is to be taught by the motion teaching unit based on the evaluation result of the motion of the user.

5. The service providing apparatus according to claim 2, further comprising:
a pressing unit provided on the seat and configured to press the user, wherein
the control device further configured to set a pressing force of the pressing unit based on the user information.

6. The service providing apparatus according to claim 2, wherein:
the control device further configured to set a detection range in which the motion of the user is detected by the detector on a seating surface of the seat based on the user information.

7. The service providing apparatus according to claim 2, wherein
the motion teaching unit is at least one of: a speaker that provides teaching by voice; a monitor or an indicator that provides teaching by display; and a vibrator that provides teaching by vibration.

8. The service providing apparatus according to claim 2, wherein
the control device determines whether any of the detector and the motion teaching unit has failed, and determines that no motion is to be taught by the motion teaching unit when it is determined that any of the detector and the motion teaching unit has failed.

9. The service providing apparatus according to claim 2, wherein
the detector is provided in correspondence with a plurality of parts of a body of the user, wherein
the control device determines the motion including a motion of each part of the plurality of parts of the body of the user.

10. The service providing apparatus according to claim 2, wherein
the control device determines a timing for the motion to be taught to the user, wherein
the motion teaching unit teaches the user the timing for the motion determined by the control device, wherein
the control device evaluates the motion of the user based on a time difference between the timing for the motion taught by the motion teaching unit and a timing with which the motion is detected by the detector.

11. The service providing apparatus according to claim 1, wherein
the detector detects a physical quantity having a correlation with a force exerted on the seat by the user, wherein
the service providing apparatus further comprises:
a portable information terminal including a selection operation unit that selects one of the presentation unit and the plurality of service functions, and configured to exchange information with the control device via communication.

12. The service providing apparatus according to claim 11, wherein
the plurality of service functions includes a posture diagnosis service function of diagnosing a seating posture of the user, wherein
the control device is further configured to perform posture diagnosis of the user based on the motion detected by the detector, wherein
the portable information terminal exchanges information with the control device via communication and displays a diagnosis result of the posture diagnosis on the presentation unit.

13. The service providing apparatus according to claim 12, wherein
the control device is further configured to perform anomaly diagnosis of the detector in addition to the posture diagnosis, wherein
the presentation unit presents anomaly information when the control device diagnoses that the detector is anomalous.

14. The service providing apparatus according to claim 11, wherein
the seat includes a plurality of divided seat parts, wherein
the detector is arranged away from an edge region of the plurality of seat parts.

15. The service providing apparatus according to claim 11, further comprising:
a seat pad attachable to and detachable from the seat, wherein
the detector is provided on the seat pad instead of the seat.

16. The service providing apparatus according to claim 11,
wherein
the control device is provided on a back surface of the seat opposite to a seating surface of the seat.
